(19) United States
(12) Patent Application Publication
(10) Pub. No.: US 2011/0249921 A1
(43) Pub. Date: Oct. 13, 2011

(54) HIDDEN TYPE SLIDING RAIL STRUCTURE

(76) Inventors: Kuo-Sheng HUANG, Ying-Ge Town (TW); Jung-Chang Chung, Ying-Ge Town (TW)

(21) Appl. No.: 12/757,559

(22) Filed: Apr. 9, 2010

(51) Int. Cl. F16C 29/04

(52) U.S. Cl. 384/18

(57) ABSTRACT

A hidden type sliding rail structure comprises a sliding rail device comprising an upper rail member and a lower rail member, the lower rail member having a sliding space therein; a sliding device comprising an upper sliding portion and a lower sliding portion respectively embedded to the upper rail member and the lower rail member; a rolling ball set disposed between the lower rail member and the lower sliding portion, the rolling ball set comprising a first rolling ball disposed to an outer side of the lower rail member, a second rolling ball disposed to an inner side of the lower rail member, and a third rolling ball disposed onto the lower rail member. Accordingly, a sliding rail composition of a drawer (a cabinet) can be prevented from being deformed to provide smooth sliding operation, thereby improving the operation quality, the service life and the product competition capability.

### BACKGROUND OF THE INVENTION

1. Field of the Invention

The present invention relates to a sliding rail structure, and more particularly to a hidden type sliding rail structure capable of preventing inclination to smoothly operate and enhance the service life.

2. Description of the Related Art

According to a drawing type (a sliding rail type) drawer or cabinet body largely applied to different kinds of containing and storage appliances, a hidden type sliding rail structure is frequently applied to the existing containing and storage appliances since its appearance has succinct composition. A conventional hidden type sliding rail structure 90, as shown in FIG. 1, comprises an upper rail member 91, a lower rail member 92 and a sliding member 93. The upper rail member 91 is slightly a tube body and forms three curved sliding ways 911, 912, 913 thereunder and thereupon. The lower rail member 92 is slightly a tube body and forms three curved sliding ways 923, 921, 922. The lower rail member 92 forms a short bending wall 925 at the outer side and a short inner wall 924 at the inner side. The curved sliding rail 921 corresponds to the short inner wall 924. The upper rail member 91 is in contact with a drawer 98 (or a cabinet body). The lower rail member 92 is connected to the fastening member 96. The fastening member 96 is fastened on a cabinet wall 97 through the fastening bolts 99. The sliding member 93 is embedded and slides between the upper rail member 91 and the lower rail member 92 and has an upper sliding portion 90A and a lower sliding portion 98B. The upper sliding portion 90A has embedding portions 931, 932, 933 corresponding to the curved sliding ways 911, 912, 913 to contain three rolling balls 94a, 94b, 94c for sliding. The lower sliding portion 90B has embedding portions 936, 934, 935 corresponding to the curved sliding ways 923, 921, 922 to contain three rolling balls 95c, 95a, 95b for sliding. The conventional hidden sliding rail structure 90 could achieve the effect of operating the sliding rail. However, the rolling balls 95c, 95b are located at the same vertical line through the composition of the lower rail member 92 and the lower sliding portion 90B. Consequently, when the weight of the drawer 98 passes through the sliding member 93 to affect the lower rail member 92, an applied force 100A (a force line) is generated by pressing the short bending wall 925 of the lower rail member 98 on the rolling ball 95c as well. The applied force 100A could be divided into a vertical force 100B (a force line) and a horizontal force 100C (a force line). The vertical line composition of the rolling balls 95c, 95b will increase the horizontal force, and the horizontal force 100C will pass through the rolling ball 95a to fully affect the short inner wall 924 so that the short inner wall 924 is deformed. The sliding member 93 will be loosed and shake while the sliding member 93 slides on the rolling ball 95a. The operation quality and the service life will be seriously influenced, and it is a worse design. Moreover, the conventional hidden type sliding rail structure 90 must be fastened on the cabinet wall 97 through a fastening member 96 to increase the component and assembly costs. The foregoing shortcomings on the conventional hidden type sliding rail structure need to be improved and overcome.

### SUMMARY OF THE INVENTION

In view of the shortcomings of the prior art, the inventor of the present invention based on years of experience in the related industry to conduct extensive researches and experiments, and finally developed a hidden type sliding rail structure capable of preventing the drawer (a cabinet body) from being deformed and providing excellent stability, more convenient assembly, and smooth sliding operation to further improve the operation quality, the service life and product competition capability.

Therefore, it is a primary objective of the present invention to overcome the aforementioned shortcoming and deficiency of the prior art by providing a hidden type sliding rail structure.

To achieve the foregoing objective, the hidden type sliding rail structure of the present invention comprises a sliding rail device comprising an upper rail member and a lower rail member, the lower rail member having a sliding space therein; a sliding device comprising an upper sliding portion and a lower sliding portion embedded to the upper rail member and the lower rail member respectively; a rolling ball set disposed between the lower rail member and the lower sliding portion. The rolling ball set comprises a first rolling ball disposed to an outer side of the lower rail member, a second rolling ball disposed to an inner side of the lower rail member, and a third rolling ball disposed onto the lower rail member. The first rolling ball, the second rolling ball and the third rolling ball are arranged as a equilateral triangle, and a gravitational vertical line of the third rolling ball is located between the first rolling ball and the second rolling ball.

It is a second objective of the present invention to further provide a hidden type sliding rail structure. The structure comprises a sliding rail device comprising an upper rail member and a lower rail member, the lower rail member having a sliding space therein, an inside of the lower rail member having an inner wall, the inner wall having an auxiliary bending wall that is protruded and bent toward a side of the sliding space; a sliding device comprising an upper sliding portion and a lower sliding portion embedded to the upper rail member and the lower rail member respectively; a rolling ball set disposed between the lower rail member and the lower sliding portion. The rolling ball set comprises a first rolling ball disposed to an outer side of the lower rail member, a second rolling ball disposed to an inner side of the lower rail member, and a third rolling ball disposed onto the lower rail member. The auxiliary bending wall being is higher than the third rolling ball.

### BRIEF DESCRIPTION OF THE DRAWINGS

FIG. 1 is a schematic diagram of a conventional hidden type sliding rail structure;

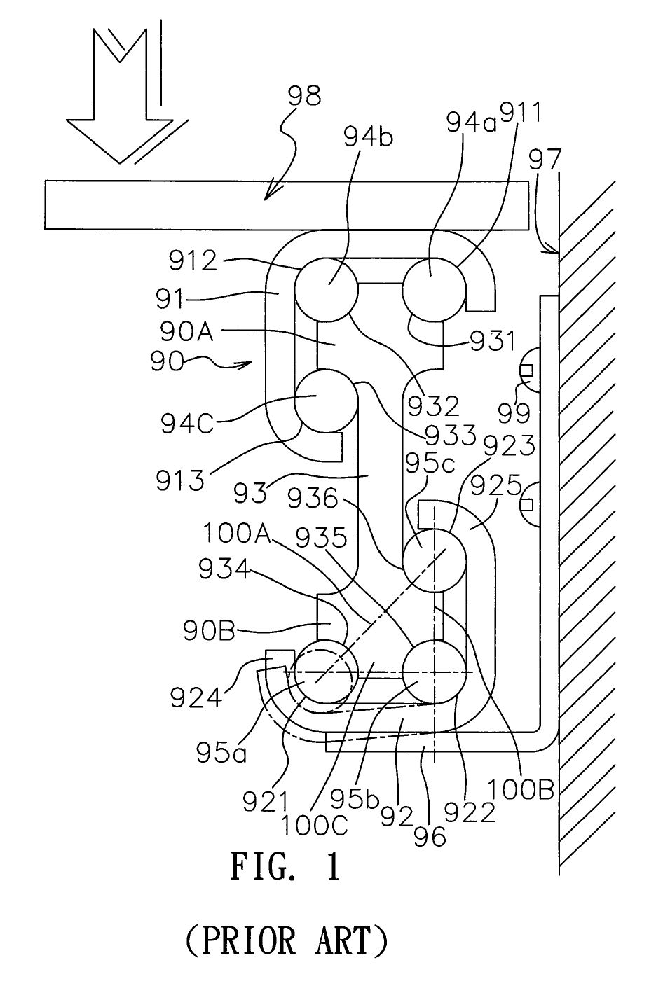

FIG. 2 is a stereogram diagram of a hidden type sliding rail structure according to the present invention;

FIG. 3 is a decomposition drawing of a hidden type sliding rail structure according to the present invention;

FIG. 4 is an assembly cross-sectional drawing of a hidden type sliding rail structure according to the present invention; and

FIG. 5 is an operating diagram of a hidden type sliding rail structure according to the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

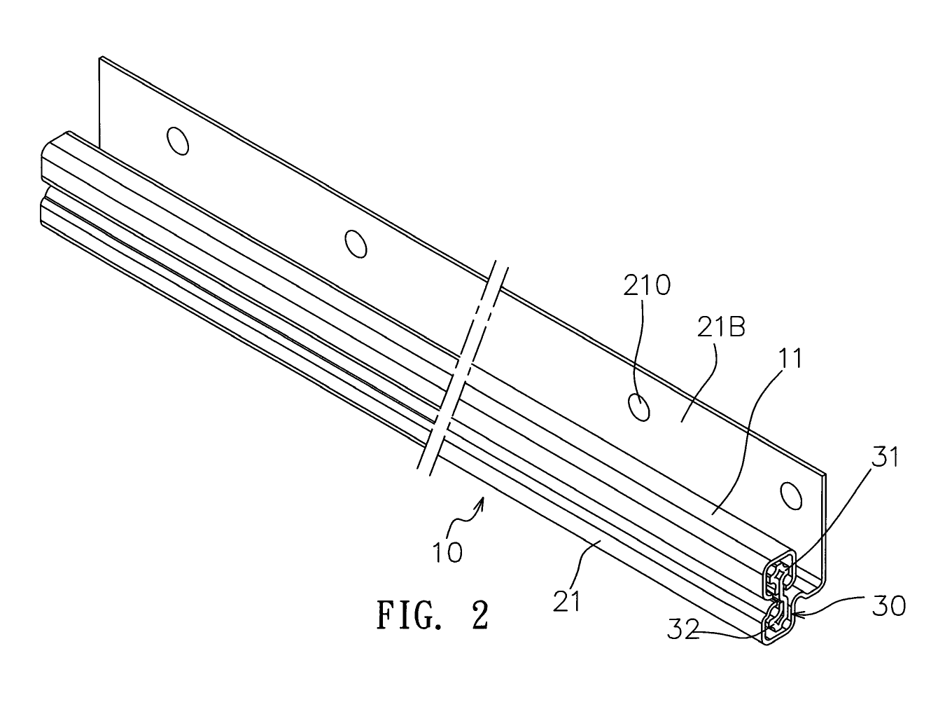

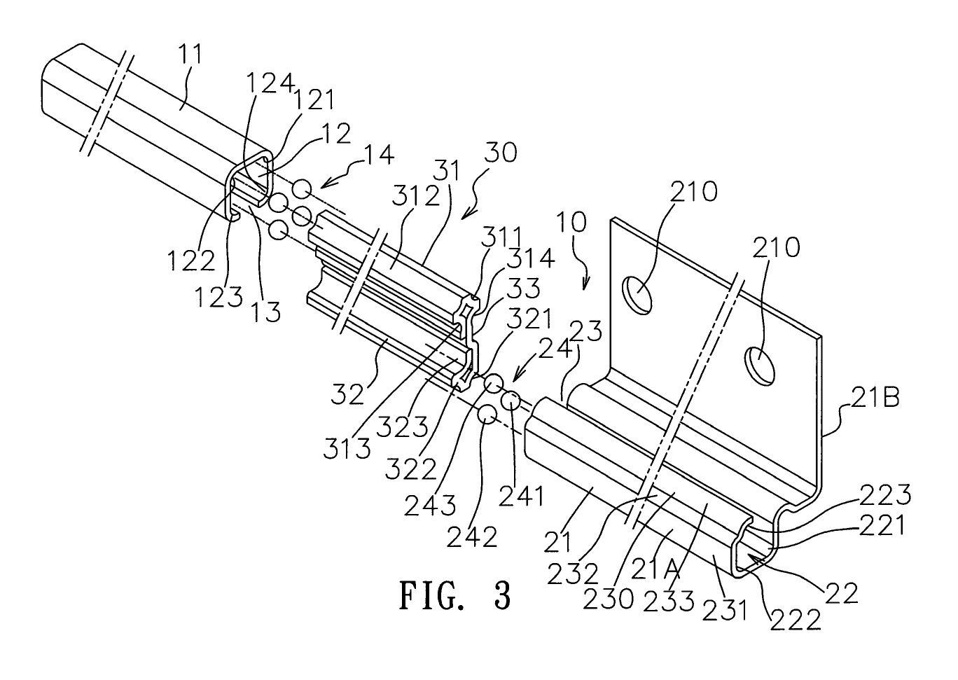

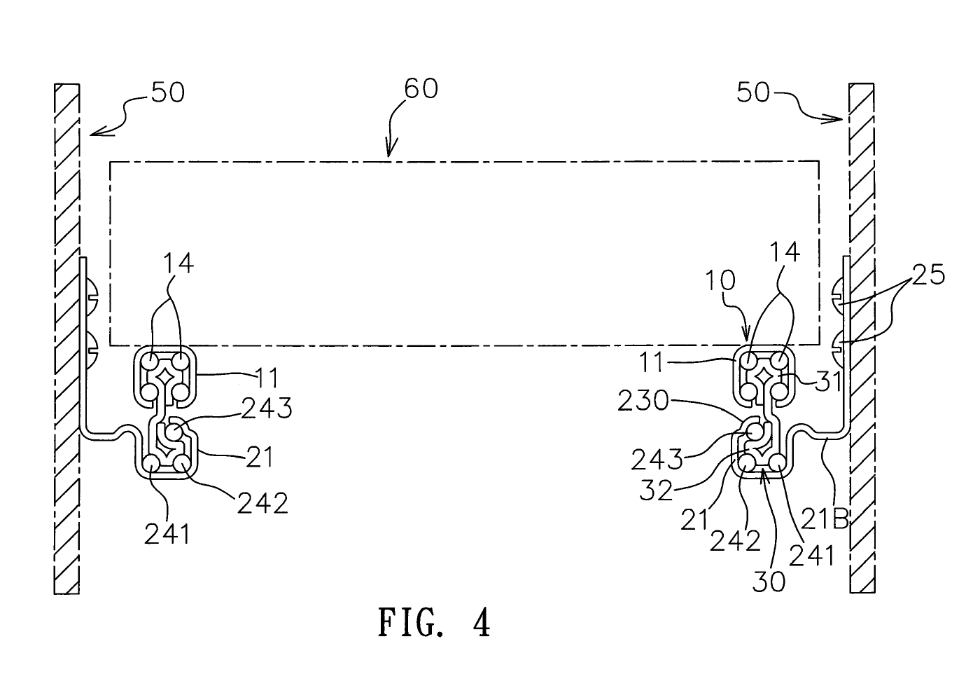

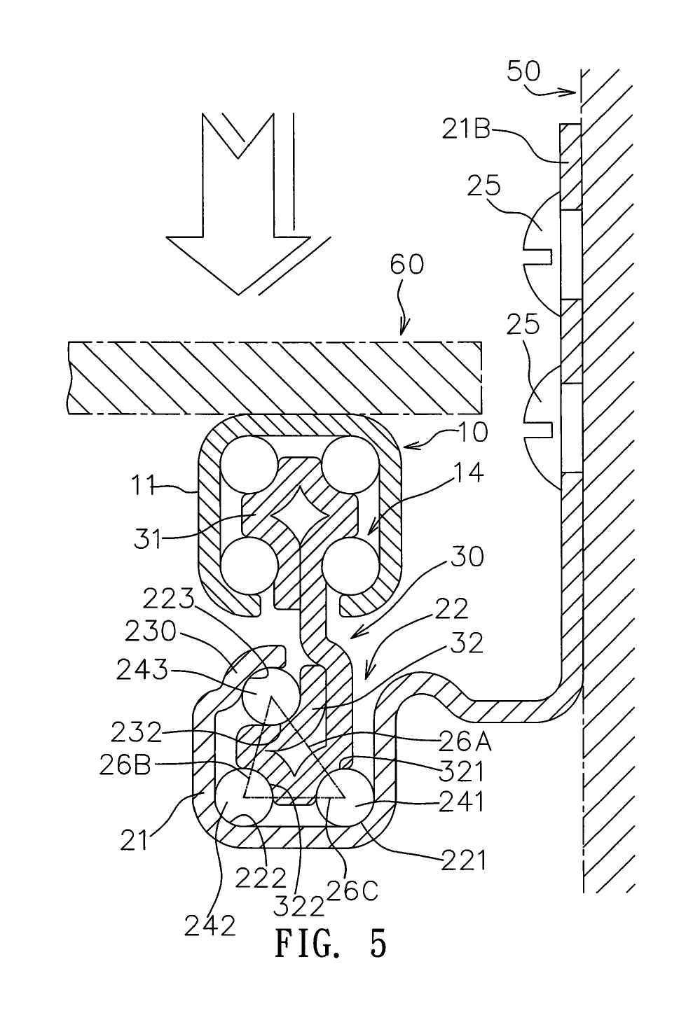

With reference to FIG. 2 to FIG. 4 for a hidden type sliding rail structure in accordance with the present invention, the structure comprises a sliding rail device 10 and a sliding device 30. The sliding rail device 10 comprises an upper rail member 11 and a lower rail member 21. The upper rail member 11 is slightly a tube body and has a sliding space 12 therein and an opening 13 under the sliding space 12. The upper rail member 11 forms four curved sliding ways 121, 122, 123 and 124 within the sliding space 11. An upper portion of the upper rail member 11 is connected to a cabinet body 60 (as shown in FIG. 5). The lower rail member 21 comprises a tube body 21A that is inwardly bent and a fastening member 21B that is outwardly bent as a bent plate. The tube body 21A of the lower rail member 21 has a sliding space 22 therein and an opening 23 thereupon. The sliding space 22 forms three curved sliding ways 221, 222, and 223. Moreover, the tube body 21A of the lower rail member 21 has an inner wall 231 therein. The inner wall 231 has an auxiliary bending wall 230 that is protruded and bent toward a side of the sliding space 22. The auxiliary bending wall 230 comprises a first bending wall 232 and a second bending wall 233. The second bending wall 233 correspondingly forms the curved sliding way 223. The fastening member 21B has a plurality of positioning holes 210. The fastening member 21B is fastened on a cabinet wall 50 (as shown in FIG. 4) through positioning bolts 25.

The sliding device 30 is embedded and slid between the upper rail member 11 and the lower rail member 21. The sliding device 30 comprises an upper sliding portion 31 and a lower sliding portion 32. A connection portion 33 is connected between the upper sliding portion 31 and the lower sliding portion 32. In a proper embodiment, the upper sliding portion 31, the connection portion 33 and the lower sliding portion 32 are integrally bent and formed. The upper sliding portion 31 has curved sliding portions 311, 312, 313 and 314 at four corners. The lower sliding portion 32 has curved sliding portions 321, 322 disposed at two lower sides and a curved sliding portion 323 thereupon. While in assembly, the upper sliding portion 31 is embedded in the sliding space 12 of the upper rail member 11, and four rolling balls 13 are disposed between the upper sliding portion 31 and the upper rail member 11. The four rolling balls 14 correspond to the curved sliding ways 121, 122, 123, 124 of the upper rail member 11 and the curved sliding portions 311, 312, 313, 314 of the upper sliding potion 31 respectively. The lower sliding portion 32 is embedded in the sliding space 22 of the lower rail member 21, and a rolling ball set 24 is disposed between the lower sliding portion 32 and the lower rail member 21. The rolling ball set 24 comprises three rolling balls 241, 242, 243. The rolling balls 241, 242 at two lower sides correspond to the curved sliding ways 221, 222 of the lower rail member 21 and the curved sliding portions 321, 322 of the lower sliding portion 32 respectively. The rolling ball 243 corresponds to the curved sliding way 223 of the lower rail member 21 and the curved sliding portion 323 of the lower sliding portion 32, and the height of the second bending wall 233 (the auxiliary bending wall 230) is higher than the rolling ball.

Moreover, since the curved sliding ways 223, 221, 222 of the lower rail member 21 correspond to the curved sliding portions 323, 321, 322, the rolling balls 243, 241, 242 are arranged as a triangle. Namely, a gravitational vertical line of the rolling ball 243 is located between the rolling balls 241, 242.

With reference to FIG. 5, the weight of the cabinet body 60 passes through the upper rail member 11 and the sliding device 30 to affect the rolling ball 24 and the lower rail member 21. When the gravity passes through the rolling balls 241, 242 to affect the lower rail member 21, an applied force 26A (a force line) is simultaneously generated by pressing the second bending wall 233 on the rolling ball 243. The applied force 26A is divided into a vertical force 26B (a force line) and a horizontal force 26C (a force line). Since the gravitational vertical line of the rolling ball 243 is located between the rolling balls 241, 242, the vertical force 26B is shared by the two rolling balls 241, 242, and the horizontal force 26C is reduced. Such design further allows the horizontal force 26C to mainly affect the rolling ball 241 disposed to an outer side (not the rolling ball 242 disposed to an inner side) so that the inner wall 231 of the lower rail member 21 that belongs to a cantilever arm arrangement can be prevented from being deformed due to excess pushing forces. The smooth sliding and the operating quality among the lower rail member 21, the rolling ball set 24 and the lower sliding portion 32 can be ensured, and its service life can be simultaneously improved.

Accordingly, the hidden type sliding rail structure of the present invention can exactly improve the defects that the inner wall of the cantilever arm arrangement is easily tilted and not straight and the rolling balls are loosed while using the conventional technique, and thus the structure can have better stability, firmness and extremely smooth operation in operating the structure to substantially enhance the operation quality, the service life and the product competition capability.

The present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

1. A hidden type sliding rail structure comprising:
a sliding rail device comprising an upper rail member and a lower rail member, the lower rail member having a sliding space therein;
a sliding device comprising an upper sliding portion and a lower sliding portion respectively embedded to the upper rail member and the lower rail member;
a rolling ball set disposed between the lower rail member and the lower sliding portion, the rolling ball set comprising a first rolling ball disposed to an outer side of the lower rail member, a second rolling ball disposed to an inner side of the lower rail member, and a third rolling ball disposed onto the lower rail member, the first rolling ball, the second rolling ball and the third rolling ball arranged as a equilateral triangle, and a gravitational vertical line of the third rolling ball located between the first rolling ball and the second rolling ball.

2. The hidden type sliding rail structure as recited in claim 1, wherein a connection portion is disposed between the upper sliding portion and the lower sliding portion, and the upper sliding portion, the connection portion and the lower sliding portion are integrally bent and formed.

3. The hidden type sliding rail structure as recited in claim 1, wherein the upper rail member comprises a sliding space therein and an opening under the sliding space, and the upper rail member forms a plurality of curved sliding ways, and the upper sliding portion has a plurality of curved sliding portions corresponding to the plurality of curved sliding ways, and rolling balls are disposed between the curved sliding ways and the curved sliding portions.

4. The hidden type sliding rail structure as recited in claim 1, wherein the lower rail member comprises a tube body that is inwardly bent and a fastening member that is outwardly bent as a bent plate, and the tube body has an upward opening, an inside of the tube body has an inner wall, and the inner wall has an auxiliary bending wall that is protruded and bent toward a side of the sliding space, and the auxiliary bending wall is higher than the third rolling ball.

5. The hidden type sliding rail structure as recited in claim 4, wherein the auxiliary bending wall of the lower rail member comprises a first bending wall and a second bending wall, and the second bending wall forms a curved sliding way corresponding to the third rolling ball, and the lower rail member forms two curved sliding ways thereunder corresponding to the first rolling ball and the second rolling ball respectively.

6. The hidden type sliding rail structure as recited in claim 5, wherein the lower sliding portion has a curved sliding portion corresponding to the curved sliding way of the lower rail member to install the rolling ball set.

7. A hidden type sliding rail structure comprising:
a sliding rail device comprising an upper rail member and a lower rail member, the lower rail member having a sliding space therein, an inside of the lower rail member having an inner wall, the inner wall having an auxiliary bending wall that is protruded and bent toward a side of the sliding space;
a sliding device comprising an upper sliding portion and a lower sliding portion embedded to the upper rail member and the lower rail member respectively;
a rolling ball set disposed between the lower rail member and the lower sliding portion, the rolling ball set comprising a first rolling ball disposed to an outer side of the lower rail member, a second rolling ball disposed to an inner side of the lower rail member, and a third rolling ball disposed onto the lower rail member, the auxiliary bending wall being higher than the third rolling ball.

8. The hidden type sliding rail structure as recited in claim 7, wherein the first rolling ball, the second rolling ball and the third rolling ball are formed as a equilateral triangle, and a gravitational vertical line of the third rolling ball is located between the first rolling ball and the second rolling ball.

9. The hidden type sliding rail structure as recited in claim 7, wherein a connection portion is disposed between the upper sliding portion and the lower sliding portion, and the upper sliding portion, the connection portion and the lower sliding portion are integrally bent and formed.

10. The hidden type sliding rail structure as recited in claim 7, wherein the upper rail member comprising a sliding space therein and an opening under the sliding space, and the upper rail member forms a plurality of curved sliding ways in the sliding space, and the upper sliding portion has a plurality of curved sliding portions corresponding to the plurality of curved sliding ways, and rolling balls are installed between the curved sliding ways and the curved sliding portions.

11. The hidden type sliding rail structure as recited in claim 7, wherein the lower rail member comprises a fastening member that is outwardly bent as a bent plate.

12. The hidden type sliding rail structure as recited in claim 7, wherein the auxiliary bending wall of the lower rail member comprises a first bending wall and a second bending wall, and the second bending wall forms a curved sliding way corresponding to the third rolling ball, and the lower rail member forms two curved sliding ways thereunder corresponding to the first rolling ball and the second rolling ball respectively.

13. The hidden type sliding rail structure as recited in claim 12, wherein the lower sliding portion comprises a curved sliding portion corresponding to the curved sliding way of the lower rail member to install the rolling ball set.
